(19) United States
(12) Patent Application Publication
(10) Pub. No.: US 2016/0320189 A1
(43) Pub. Date: Nov. 3, 2016

(54) METHOD FOR NAVIGATION AND JOINT COORDINATION OF AUTOMATED DEVICES

(71) Applicants: Oleg Yurjevich Kupervasser, Moscow (RU); Yury Iljich Kupervasser, Moscow (RU); Alexander Alexandrovich Rubinstein, Moscow (RU)

(72) Inventors: Oleg Yurjevich Kupervasser, Moscow (RU); Yury Iljich Kupervasser, Moscow (RU); Alexander Alexandrovich Rubinstein, Moscow (RU)

(21) Appl. No.: 14/700,180

(22) Filed: Apr. 30, 2015

(51) Int. Cl. G01C 21/00; G01S 19/13

(52) U.S. Cl. CPC G01C 21/00; G01S 19/13

(57) ABSTRACT

The invention relates to methods for controlling automated devices. The method comprises locating at least one automated device on an area being controlled and placing an observation device, before the automated device starts operation, over the area being controlled on a flying device or tower, said observation device being capable of receiving and transmitting a control signal to the automated device and determining the coordinates of the flying device, whereupon said observation device controls at least said one automated device. The invention simplifies control of the automated device and improves the accuracy with which its coordinates are determined.

### CROSS-REFERENCE TO RELATED APPLICATIONS

This application is a continuation of International Application No. PCT/RU2013/000984 filed on Nov. 7, 2013, which claims benefit of priority to Russian Application No. 2012147923 filed on Nov. 12, 2012, both of which are incorporated by reference herein. This application is a continuation of International Application No. PCT/RU2013/000983 filed on Nov. 7, 2013, which claims benefit of priority to Russian Application No. 2012147924, filed on Nov. 12, 2012, both of which are incorporated by reference herein.

### FIELD OF THE TECHNOLOGY

The invention relates to methods for controlling automated devices and can be used for coordinating robot-controlled gardening machines, for example, lawn mowers.

### BACKGROUND

Absence of an inexpensive and reliable navigation system and lack of mutual coordination of operations are among the basic problems of video navigation, coordination, and control of robotized lawn mowers.

For example, to prevent a robot-controlled lawn mower from running beyond the grass mowing area, a wire must used to encircle the area. The navigation system of a majority of commercial robots can only have them roam randomly (see: http://www.3news.ru/tags/%D0%BA%D0%/BE%D1%81%D0%B8%D0%BB%D0%BA%D0% BO).

Systems of infrared fences or marks have been developed lately. A system of ground radio beacons can also be used. These types of systems, however, are very expensive and complicated.

The most recent developments are advanced DGPS-based systems. DGPS is the best choice because the common GPS does not assure sufficient accuracy of positioning. This most advanced system is not without problems either. First, the GPS signal may be screened near houses, or be reflected several times, or suppressed by disturbances or deliberately. As a result, robot coordination is disrupted. Second, the coordinates of the lawn boundary have to be measured and entered into the robot, a hard effort to accomplish. Third, DGPS provides the coordinates, rather than robot orientation. Fourth, the system is adjusted to abstract coordinates, rather than the real setting of the robot. For example, the robot does not detect a stationary or moving obstacle (a dog or child). Fifth, DGPS does not recognize if there is grass to be mowed on the lawn or not. Sixth, DGPS has difficulty organizing mutual coordination of the robots that are unaware of their mutual position and must be equipped with a complicated system for mutual detection and exchange of signals. Seventh, this system is expensive.

Many of these problems could be solved by a video navigator fitted on the robot. This would create more problems—the video navigator has a limited field of vision that can only be expanded by providing a large number of cameras or cameras having a wide field of vision. This is a complicated and costly undertaking. Besides, many complicated ground marks are to be set up and be well distinguished. Natural landmarks are not always distinguished well. The area to be mowed certainly has to be provided with ground marks. And again, it is difficult to coordinate robots among themselves.

### DESCRIPTION OF INVENTION

This invention is intended to solve these problems and eliminate the deficiencies referred to above.

This invention, if used as herein described, simplifies control of an automated device and improves the accuracy with which its coordinates are determined.

This technical result is achieved in the claimed method for navigation and joint coordination of automated devices, said method comprising placing at least one automated device on the area being controlled such that, according to the invention, an observation apparatus is located, before the start of operation of the automated device, above the area being controlled on a flying device or put up on a tower, said apparatus being capable of receiving and transmitting a control signal to the automated device and being also capable of determining the coordinates of the flying devices, said apparatus being thereafter used to control at least one automated device.

The invention is illustrated in the drawing showing one of possible embodiments of the claimed method. The drawing illustrates an air sonde carrying a camera; marks on the ground and on the robot-controlled lawn mower; and a natural reference point such as a bush.

The claimed method is performed as follows: first, at least one automated device (a robot-controlled lawn mower) is located on the area (lawn) being controlled. Before the automated device starts operation, a tracking device (such as a camera) is positioned above the area being controlled on a flying device such as a sonde balloon or a pilotless vehicle of helicopter type, or said device can be positioned on a tower of a height allowing the entire area being controlled to be viewed. The device is capable of receiving and transmitting a control signal from and to the automated device and also of determining the coordinates of the flying device. The device also can exchange signals, including RF signals, with the robots. The camera observes the robot and determines its position relative to itself. Marks distinguished easily from above can be placed on the robot and its charging device. If several robots are used, their mutual coordination is easy enough—the camera sees them all at a time, and a computer system receiving data from the camera coordinates their mutual movement easily. The boundaries of the area to be mowed by a robot-controlled lawn mower can be drawn on the computer system screen by the mouse pointer, or by a sensor pencil, or a finger on the screen.

Furthermore, a visible signal can be replaced with other regions of the spectrum. The signal received can be both natural and generated by the robot or device on the camera, or at any other point of the area. Equally suitable are sound, smell or chemical signals, or radioactivity slightly above the background level (for example, silicon plates).

The system can easily see obstacles or moving objects and determine the extent and quality of grass mowing. It is simple in design and has a low cost.

The claimed system can be used with a broad class of robots: automated lawn mowers, robotized room cleaners, tractors, snowplows, garbage collectors, street cleaners, vehicles liar transporting people and freight, and even extraterrestrial robots on other plants, for example, on Mars.

The system fits easily into the framework of an “intelligent” home, or even an “intelligent” city, being capable of coordinating many actions, robots, and objects at a time, and performing several tasks simultaneously, for example, navigation and recognition.

The invention has been disclosed above with reference to a specific embodiment thereof. Other embodiments that do not depart from the idea of the invention as it is disclosed herein may be obvious to people skilled in the art. Accordingly, the description of the invention may be considered limited in scope by the following claim only.

What is claimed is

1. A method for navigation and joint coordination of automated devices, placed at an area being controlled, by developing routing for every automated device according to information about coordinates of obstacles, boundaries of a treated area, boundaries of the controlled area, which are defined by an user by drawing boundaries of the controlled area on image of the controlled area, and coordinates of all automated devices on the controlled area, whose distinctive features are that for making possible operation of automated devices on the controlled area, mainly on the parts of the controlled area, where a signal from GPS satellites is screened or rerefracted, before the automated devices start to operate over the area being controlled, an observation device is positioned on a flying device or on a tower or on a tethered observation platform for tracking the automated devices on the area being controlled and observation of its environment, including natural and artificial landmark, said observation device being capable of transmitting to the at least one automated device information about the area being controlled and objects on this area, the at least on one automated device this information is processed for calculation of coordinates of the observation device, coordinates of all automated devices on the controlled area, coordinates of obstacles, boundaries of a treated area, boundaries of the controlled area, verification that automated devices do not pass boundary of the controlled area, drawn by the user on the image of the controlled area, and also exchange by control signals is possible between automated devices and observation device for joint coordination.

2. A method for navigation and joint coordination as in claim 1, whose distinctive feature is that calculation of coordinates of obstacles, boundaries of a treated area, boundaries of the controlled area, and coordinates of all automated devices on the controlled area from observation device's information about the area being controlled and objects on this area, is processed on the observation device.

3. A method for navigation and joint coordination as in claim 1, whose distinctive feature is that calculation of coordinates of obstacles, boundaries of a treated area, boundaries of the controlled area, and coordinates of all automated devices on the controlled area from observation device's information about the area being controlled and objects on this area, is processed on unmoving post , and also exchange by control signals and information between automated devices, observation device, and unmoving post is possible, and also automated devices can get energy charge from unmoving post.

4. A method for navigation and joint coordination as in claim 1, whose distinctive feature is that observation device can be initially placed on the ground, on one from automated device, or on unmoving post, and after beginning of automated device's operation can fly up, fly, fly down on the towers tier convenience of automated device's tracking on the controlled area.

5. A method for navigation and joint coordination as in claim 1, whose distinctive feature is that the system is possible to recognize and find coordinates of dangerous moving objects such as children or animals.
